(19) United States
(12) Patent Application Publication
(10) Pub. No.: US 2024/0117134 A1
(43) Pub. Date: Apr. 11, 2024

(54) WATERPROOF MEMBRANE, PREPARATION METHOD AND CONSTRUCTION METHOD THEREOF, AND TUNNEL WATERPROOF SYSTEM

(71) Applicant: BEIJING ORIENTAL YUHONG WATERPROOF TECHNOLOGY CO., LTD., Beijing (CN)

(72) Inventors: Yuqin XIONG, Beijing (CN); Chaoqun WANG, Beijing (CN); Nan CHEN, Beijing (CN); Kai LI, Beijing (CN)

(21) Appl. No.: 18/542,283

(22) Filed: Dec. 15, 2023

Related U.S. Application Data
(63) Continuation of application No. PCT/CN2022/096283, filed on May 31, 2022.

(30) Foreign Application Priority Data
Jun. 18, 2021 (CN) 2021106797224
Jun. 18, 2021 (CN) 2021213616727

(51) Int. Cl. C08J 7/04; C08K 5/00; C08L 23/06; C09D 5/00; C09D 5/02; C09D 7/48; C09D 7/61; C09D 7/65; C09D 125/14; C09D 133/04; C09D 153/02; E21D 11/10; E21D 11/38

(52) U.S. Cl. CPC C08J 7/042; C08K 5/005; C08L 23/06; C09D 5/002; C09D 5/022; C09D 7/48; C09D 7/61; C09D 7/65; C09D 125/14; C09D 133/04; C09D 153/02; E21D 11/107; E21D 11/383; C08J 2323/06; C08J 2423/06; C08J 2425/08; C08J 2433/04; C08J 2453/02; C08J 2491/00; C08L 2201/08; C08L 2205/025; C08L 2207/066

(57) ABSTRACT

The present disclosure belongs to the technical field of waterproofing, and relates to a waterproof membrane, a preparation method and a construction method thereof, and a tunnel waterproof system. The waterproof membrane includes a resin sheet layer, a non-asphalt-based macromolecular self-adhesive layer and an interface bonding layer which are sequentially disposed, where the waterproof membrane has a light transmittance of ≥45%. The present disclosure provides a visual waterproof membrane, that is, light may penetrate through the membrane to make gaskets visual, and when the membrane has a light transmittance of ≥45%, it has good visibility for gaskets with warm colors such as orange and red.

### CROSS-REFERENCE TO RELATED APPLICATIONS

The present application is a continuation of International Application No. PCT/CN2022/096283, filed on May 31, 2022, which claims priority to Chinese Patent Application Nos. 2021106797224, filed on Jun. 18, 2021, and 2021213616727, filed on Jun. 18, 2021. The disclosures of the aforementioned applications are hereby incorporated by reference in their entireties.

### TECHNICAL FIELD

The present disclosure belongs to the technical field of waterproofing, and particularly relates to a waterproof membrane, a preparation method and a construction method of the waterproof membrane, and a tunnel waterproofing system.

### BACKGROUND

Since the tunnel has been constructed by mining method or New Austrian Tunneling Method (NATM), the waterproof problem of composite lining is generally solved by setting a waterproof layer between the shotcrete layer and the secondary lining. The constructed waterproof layer usually adopts PVC (Polyvinyl Chloride), EVA (Ethylene-Vinyl Acetate), ECB (Ethylene Copolymer Bitumen), LLDPE (Linear Low Density Polyethylene) and other waterproof boards. These traditional waterproof boards have smooth surfaces and cannot form an effective interlocking with the secondary lining concrete. Once the waterproof membrane is broken or the welding is not reliable, a phenomenon called “water channeling” will occur between the waterproof layer and the second lining concrete, and then water will enter into the tunnel through concrete cracks and gaps.

In recent years, some tunnels use self-adhesive macromolecule waterproof membrane, which seems to improve the waterproofing effect compared with single-layer polymer waterproof board, but in fact it is not the case. After the waterproof construction is completed, reinforcing bars need to be tied. During the moving cycle of a trolley, the isolation film on the surface of the self-adhesive membrane must be torn off first. In this process, the membrane is very easily adhered to the body and clothes of operators. In addition, the dust from the processes of tunnel blasting, muck removal, etc. may be directly adsorbed on the surface of the adhesive film to become an isolation layer, which may lose its ability to adhere to the post-poured concrete; in some cases, if the isolation film of the membrane is not removed during the pouring of concrete, it will completely lose its bonding effect with the concrete, facing the same problem as the traditional waterproof board. Once “water channeling” occurs, it is difficult to lock the leakage location, which makes the subsequent leakage detection, repair and other work very difficult.

In addition, the laying of waterproof boards or membranes in tunnels requires the pre-laying of gaskets to achieve their fixation with a first lining concrete. Laying PE and EVA waterproof boards in the tunnel mainly adopts a gasket-anchoring welding method, and the welding method is divided into hot air welding, ultrasonic welding and electromagnetic welding. In the current construction process, it is necessary to weld from the back to fix the membrane. Due to large size of the membrane, the construction process of welding from the back of the membrane is very complex and time-consuming for the tunnel vault, and the technical requirements for operators are also high. Electromagnetic welding can support the operation on the front of the membrane to achieve the welding with the gasket, which is more convenient for workers to operate. However, the front operation requires the waterproof boards to be transparent or translucent, so that the gasket can be accurately positioned through the material. However, the existing commercially available pre-laid macromolecule self-adhesive film membranes are all light-colored or even white, which does not meet the operation requirements. Especially, when the existing whiteness value is greater than 65%, it is not possible to find the gasket under tunnel light conditions. The light transmittance and visibility are not mentioned in the pre-laid waterproof materials reported in the relevant literature or patents, which focus on how the reverse-adhering layer plays a role in isolation, reflection and anti-adhesion with the post-poured concrete.

Therefore, at present, there are no commercially available pre-laid products or related literature reports in which gaskets can be accurately positioned through the membrane under the light environment of tunnels, so as to weld and fix the membrane and gaskets from the front of the membrane by an electromagnetic welder.

### SUMMARY

Through years of research in the technical field of waterproofing, the inventor of the present disclosure finds that the problem of “water channeling” between a waterproof layer and a secondary lining concrete may be effectively solved by replacing a traditional waterproof board with a waterproof membrane of a pre-laid reverse-adhering macromolecular self-adhesive film. It is further designed as a membrane with a certain transparency, so that gaskets may be accurately positioned through the membrane, and sheets may be weld with gaskets through electromagnetic welding, thus solving the problem caused by front construction and fixation. Based on this, the present disclosure is completed.

The purpose of the present disclosure is to overcome the above problems in the prior art, and to provide a visual waterproof membrane, that is, light may pass through the membrane to make gaskets visual, and when the membrane has a light transmittance of ≥45%, it has good visibility for gaskets with warm colors such as orange and red.

In order to achieve the above purpose, the present disclosure provides a waterproof membrane, including a resin sheet layer, a non-asphalt-based macromolecular self-adhesive layer and an interface bonding layer which are sequentially disposed, where the waterproof membrane has a light transmittance of ≥45%, and the waterproof membrane has a light transmittance of 60-70% in a possible implementation; the resin sheet layer has a thickness of 0.2-2.0 mm and a light transmittance of ≥55%. In a possible implementation, the light transmittance of the membrane in the range may achieve the best performance and convenient construction.

On the premise of satisfying the above light transmittance, in a possible implementation, each layer satisfies the following conditions: the resin sheet layer has a thickness of 0.5-1.5 mm and a light transmittance of ≥70%; the non-asphalt-based macromolecular self-adhesive layer has a thickness of 0.1-1.0 mm, and the non-asphalt-based macromolecular self-adhesive layer has a thickness of 0.15-0.5 mm in a possible implementation, and the non-asphalt-based macromolecular self-adhesive layer has a light transmittance of ≥80%, for example, 81%, 82%, 83%, 84%, 85%, 86%, 87%, 88% and 89%, and the non-asphalt-based macromolecular self-adhesive layer has a light transmittance of ≥90% in a possible implementation, for example, 91%, 92%, 93%, 94% and 95%; the interface bonding layer has a coating weight of 20-150 g/m² and a light transmittance of ≥55%. The above thickness is preferred, and those skilled in the art may adjust the thickness of the relevant composition according to the application needs on the premise of satisfying the overall light transmittance.

According to the present disclosure, in a possible implementation, the resin sheet layer is made of a polyolefin resin composition, and the polyolefin resin composition includes the following components by a total weight of the polyolefin resin composition: 0.05-2 wt. % (weight percent) of light stabilizer, 0.2-5 wt. % of antioxidant, 0.05-2 wt. % of ultraviolet absorber, and 95-99.7 wt. % of polyolefin resin; and in a possible implementation, the polyolefin resin composition includes the following components by a total weight of the polyolefin resin composition: 0.1-1 wt. % of light stabilizer, 0.2-3 wt. % of antioxidant, 0.5-1 wt. % of ultraviolet absorber and 95-99.2 wt. % of polyolefin resin.

The polyolefin resin may be selected more broadly and may be at least one of polyethylene, vinyl copolymer, polypropylene, propylene-based copolymer, poly (1-butene), poly (4-methyl-1-pentene), and cycloolefin polymer; in a possible implementation, the vinyl copolymer is ethylene-vinyl acetate copolymer, ethylene-acrylic acid copolymer, or ethylene-acrylate copolymer.

According to a possible implementation of the present disclosure, the polyolefin resin is polyethylene, and in a possible implementation, the polyolefin resin is a mixture of linear low-density polyethylene resin and medium-high-density polyethylene resin; and based on a total weight of the polyolefin resin, the linear low-density polyethylene resin has a content of 35-75 wt. % and the medium-high-density polyethylene resin has a content of 25-65 wt. %.

In a possible implementation, the linear low-density polyethylene resin has a density of 0.915-0.935 g/cm³, and in a possible implementation, the linear low-density polyethylene resin has a density of 0.920-0.935 g/cm³; and the linear low-density polyethylene resin has a melt index 12.16 of 0.1-8 g/10 min, and in a possible implementation, the linear low-density polyethylene resin has a melt index 12.16 of 0.2-3 g/10 min. The above linear low-density polyethylene resin is commercially available, for example, under brands of LLDPE-7042 (Qilu), Dowlex 2045G.

In a possible implementation, the medium-high-density polyethylene resin has a density of 0.938-0.968 g/cm³, and the medium-high-density polyethylene resin has a density of 0.938-0.948 g/cm³ in a possible implementation; and the medium-high-density polyethylene resin has a melt index 12.16 of 0.1-8 g/10 min, and the medium-high-density polyethylene resin has a melt index 12.16 of 0.2-3 g/10 min in a possible implementation. The above medium-high-density polyethylene resin is commercially available, for example, under brands of ENABLE 4009MC, HDPE TR144.

Since transportation, storage and construction are performed under a visible light environment and require a short exposure period, the light stabilizer is a hindered amine light stabilizer in one possible implementation, and is at least one of 2-(3,5-di-tert-butyl-4-hydroxybenzyl)-2′-n-butyl bis(1,2,2,6,6-pentamethyl-4-piperidyl) malonate, bis(1,2,2,6,6-pentamethyl-4-piperidyl) sebacate, and tetrakis(2,2,6,6-tetramethyl-4-piperidinyl)-1,2,3,4-butane tetracarboxylate in one possible implementation.

The above light stabilizer may be commercially available, and specifically, the light stabilizer may be at least one selected from a group consisting of UV-237, UV-531, UV-360, BASF Light Stabilizer UV783, BASF Light Stabilizer 2020 (Chimassorb 2020), BASF Light Stabilizer 622SF, and BASF light stabilizer UV791.

According to the present disclosure, the antioxidant is selected from pentaerythritol tetrakis (3,5-di-tert-butyl-4-hydroxyphenyl) propionate and/or 1,3,5-trimethyl-2,4,6-tris-(3,5-di-tert-butyl-4-hydroxy-phenyl) benzene in one possible implementation. The above antioxidants are commercially available, for example, Thanox B225 and Thanox 1010 purchased from Tianjin Lianlong New Materials Co., Ltd.

According to the present disclosure, in a possible implementation, the UV absorber is selected from hydroxyphenyl triazine ultraviolet absorber and/or benzotriazole ultraviolet absorber. In a possible implementation, the hydroxyphenyl triazine ultraviolet absorber is 2,4-bis(2,4-dimethylphenyl)-6-(2-hydroxy-4-n-octyloxyphenyl)-s-triazine, 2,4,6-tris(2-hydroxy-4-hexyloxy-3-methylphenyl)-s-triazine, 2-[2-hydroxy-4-(2-ethylhexyloxy)phenyl]-4,6-diphenyl-s-triazine, 2-[[2-hydroxy-4-[1-(2-ethylhexyloxycarbonyl)ethoxy]phenyl]]-4,6-diphenyl-s-triazine; and the benzotriazole ultraviolet absorber is 2-(5-chloro-2H-benzotriazole-2-yl)-6-tert-butyl-4-methylphenol and/or 2-(5-chloro-2-benzotriazolyl)-6-tert-butyl-p-cresol. The above UV absorbers are commercially available, for example, Tinuvin 326 purchased from BASF.

According to the present disclosure, a method for preparing the polyolefin resin composition may include the follow steps: sequentially adding a light stabilizer, an antioxidant, an ultraviolet absorber and a polyolefin resin into a mixer, stirring at a high speed for 10-15 min, extruding the mixed material through a single screw, performing three-roller calendering, cooling, shaping and winding, with a temperature of the extruder set to be 190° C.-200° C.-220° C.-220° C.-220° C.

In the present disclosure, the adhesive material of the non-asphalt-based macromolecular self-adhesive layer may be various non-asphalt-based macromolecular self-adhesives meeting the above requirements, such as a non-asphalt-based macromolecular self-adhesive pressure-sensitive adhesive, which is particularly one or more of hot-melt pressure-sensitive adhesive of EVA, hot-melt pressure-sensitive adhesive of SIS, butyl rubber-based adhesive, polyisobutylene-based adhesive, acrylic-based adhesive, ethylene-vinyl acetate copolymer adhesive, styrene-isoprene-styrene(SIS)-based adhesive, styrene-ethylene-butylene-styrene(SEBS)-based adhesive, styrene-butadiene-styrene(SBS)-based adhesive, and styrene-butadiene rubber(SBR)-based adhesive in a possible implementation.

According to another embodiment of the present disclosure, a material of the non-asphalt-based macromolecular self-adhesive layer includes non-asphalt-based macromolecular elastomer, naphthenic oil, tackifying resin, ultraviolet absorber and antioxidant; in a possible implementation, based on a total weight of the non-asphalt-based macromolecular self-adhesive layer, the non-asphalt-based macromolecular elastomer has a content of 30-48 wt. %, the naphthenic oil has a content of 5-15 wt. %, the tackifying resin has a content of 45-60 wt. %, the ultraviolet absorber has a content of 0.1-2 wt. %, and the antioxidant has a content of 0.1-2 wt. %. The naphthenic oil, tackifying resin, ultraviolet absorber and antioxidant may be conventionally selected in the art.

According to the present disclosure, the interface bonding layer is a coating layer, and in a possible implementation, a raw material of the interface bonding layer includes the following components in percentage by mass:

| | |
|---|---|
| deionized water | 10-50% |
| dispersant | 0.5-5% |
| wetting agent | 0.5-5% |
| defoamer | 0.1-3% |
| rheology modifier | 0.1-3% |
| pH buffer | 0.1-3% |
| thickener | 0.1-3% |
| first filler | 0.5-5% |
| second filler | 20-50% |
| emulsion | 10-40% |

where the first filler is a nano-scale inorganic particle and is selected from at least one of nano-silica, nano-rutile-type titanium dioxide, nano zinc oxide, nano antimony-doped tin dioxide, nano alumina, nano zirconia, and nano calcium carbonate;
the second filler is selected from at least one of barium sulfate, calcium carbonate, quartz powder, aluminum silicate, microsilica, and glass powder;
the emulsion is at least one of acrylic polymer emulsion, methacrylic polymer emulsion, acrylic acid-methacrylic acid copolymer emulsion, styrene-acrylic acid copolymer emulsion, pure acrylic emulsion, ethylene-vinyl acetate copolymer emulsion, and polyvinyl acetate emulsion.

According to the present disclosure, the waterproof roll may include an isolation film layer as needed, the isolation film layer being disposed on another side of the interface bonding layer.

In a possible implementation, a single end or both ends of the waterproof membrane are provided with a welded edge or a self-adhesive overlapping edge. When both ends are provided with self-adhesive overlapping edges, the setting mode of the upper surface, lower surface, or upper surface or upper and lower surfaces of both ends may be selected. The width and length of the welded edge or the overlapping edge are not particularly limited in the present disclosure.

The present disclosure further provides a method for preparing the above waterproof membrane, including the following steps:
S1, melting and extruding raw materials of a resin sheet layer, calendering, and molding to obtain the resin sheet;
S2, coating a hot-melt non-asphalt-based macromolecular self-adhesive on one surface of the resin sheet to form a self-adhesive layer;
S3, uniformly coating raw materials of an interface bonding layer on a surface of the self-adhesive layer of the sheet obtained in step S2, and drying to form the interface bonding layer. The obtained material has a three-layer structure as a whole, including a sheet layer, an adhesive layer and an interface bonding layer.

According to one specific embodiment of the present disclosure, firstly, raw materials of the resin sheet layer are melted and extruded by a single-screw extruder, and the extruded high-temperature melt is calendered by a three-roller calender to reach a set thickness, so as to form a sheet; then, the sheet is unwound through an unwinding drum, the unwound sheet is conveyed between a glue roller and a pressure roller through a guide roller, and the glue roller rotates to spread the non-asphalt-based macromolecular self-adhesive hot melt adhesive on a surface of the glue roller onto one surface of the sheet; then, a slurry of the interface bonding layer is prepared according to the formula and is uniformly mixed, a proper amount of the slurry is uniformly coated on the semi-finished sheet coated with the glue, and the waterproof membrane is obtained after the coating is dried.

The waterproof membrane of the present disclosure is very convenient to construct. According to one specific embodiment, the construction method includes the following steps: adopting a pre-laid reverse-adhering method for construction, where the membrane and a base layer are laid emptily, and after laying, the reinforcing bars are directly tied without applying a protective layer, and then the structural concrete is poured.

During construction in a tunnel, the method may include the following steps: adopting a pre-laid reverse-adhering method for construction, where the membrane is fixed on a first lining concrete through a gasket, and after laying, the reinforcing bars are directly tied without applying a protective layer, and then the structural concrete is poured to form full bonding between the membrane and a second lining concrete.

In a possible implementation, the gasket adapted to the construction method has warm color, for example, orange or red.

The present disclosure further provides a tunnel waterproof system, including, sequentially from inside to outside, an initial support layer, a geotextile underlay layer, a transparent or translucent waterproof membrane layer and a secondary lining layer, where the waterproof membrane layer is fixed on the initial support layer through a nailing gasket; and the waterproof membrane layer is a layer formed by the above waterproof membrane.

As previously mentioned, in a possible implementation, the color of the nailing gasket is a warm color, for example, orange or red.

The waterproof membrane of the present disclosure has the following advantages:
1. It is pollution-resistant, and the construction site is neat and beautiful. There is no particle product falling off at the construction site, which affects the welding of overlapping edges. Due to various environmental factors such as dust, moisture, standing water and sand mixing in the tunnel construction site, white membrane products are very vulnerable to pollution, resulting in an unclean and unattractive construction site. The waterproof membrane of the present disclosure has a perspective effect, and thus may be better integrated with the concrete tunnel, which keeps the construction site neat and clean.
2. When the waterproof membrane of the present disclosure is paved, gaskets may be rapidly positioned; the membrane is fixed by the front operation, and the construction speed is high. Compared with the method of welding and fixing from the back, two thirds of time may be saved, so that the construction efficiency is greatly improved, and the technical requirements for operators are reduced.
3. It is convenient for maintenance. The single-pass fortification of the membrane may meet the first-level waterproof requirement. Due to the setting of an interface bonding layer, on the one hand, after the paving is completed, no protective layer is required to be applied, the reinforcing bars are directly bound, and the structural concrete is poured; on the other hand, the interface bonding layer does not affect the full bonding of the self-adhesive layer and the structural concrete, so that a composite waterproof system is really realized, water leakage and water channeling are avoided to the greatest extent, and the maintenance and repair cost is reduced.
4. Compared with self-adhesive waterproof boards, subsequent construction procedures may be normally performed by people after tearing off the optionally disposed isolation film, and the waterproof membrane is trafficable. The interface bonding layer does not change color and whiten when it meets water, and does not lose its isolation effect, and in the case of blasting dust, it may still achieve full bonding with concrete.
5. The waterproof membrane of the present disclosure may be bonded with concrete with a peel strength of 1.5 N/mm or more, where the peel strength under soaking in water first and then being bonded with concrete may reach 1.5 N/mm or more, and the peel strength under being bonded with concrete first and then soaking in water may reach 2.0 N/mm or more. It may be welded with both overlapping edges in a tunnel, and the light transmittance of the membrane does not change due to moisture absorption during construction in a humid environment in the tunnel.

Other features and advantages of the present disclosure will be described in detail in the subsequent description of embodiments.

### BRIEF DESCRIPTION OF DRAWINGS

Exemplary embodiments of the present disclosure are described in more detail with reference to the accompanying drawings.

FIG. 1 shows visual observation results of waterproof membranes with different transparencies on a red gasket under a tunnel light condition. From top to bottom, the transparencies of the three membranes are 40%, 45% and 65%, respectively. Under the tunnel light condition, when observing the red gasket through the membrane with naked eyes, the position of the gasket cannot be identified at all when the light transmittance is 40%; the position of the gasket can be judged when the light transmittance is 45%, which meets the requirements of subsequent operations; and, the position of the gasket is clearly visible when the light transmittance is 65%.

FIG. 2 is a structural schematic diagram of a tunnel waterproofing system according to the present disclosure. Where, 1-initial support layer, 2-geotextile lining layer, 3-waterproof membrane layer, 4-secondary lining layer, and 5-nailing gasket.

FIG. 3 is a structural schematic diagram of a waterproof membrane layer adopted by the present disclosure. Where, 6-resin sheet layer, 7-non-asphalt-based macromolecular self-adhesive layer, 8-interface bonding layer, and 9-isolation film layer.

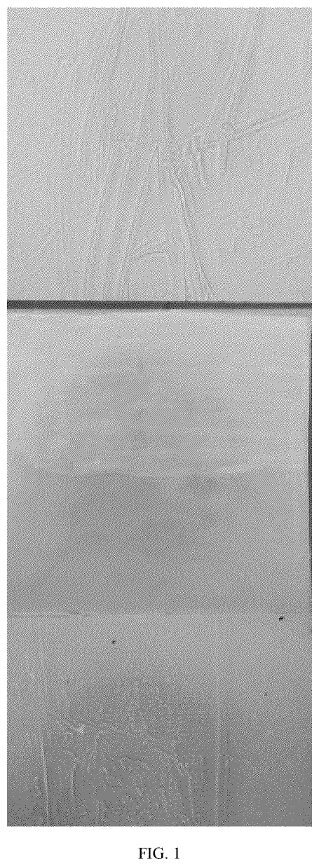

### DESCRIPTION OF EMBODIMENTS

Preferred embodiments of the present disclosure are described in more detail below. Although preferred embodiments of the present disclosure are described below, it should be understood that the present disclosure may be implemented in various forms and should not be limited by the embodiments set forth herein.

The test methods for each parameter in the following examples are as follows:

I. Coating Layer Thickness Test Method

1. Instruments and Equipment

Optical microscope, cutter, steel ruler

2. Operation Steps

First, the sheet is cut into thin strips with a cutter: 20 mm-30 mm in length and 2 mm-3 mm in width; then the sample is placed vertically on the carrier stage of the microscope, with the cross section facing upward; and the microscope is magnified to a suitable magnification (generally about 50 times) to take pictures, and the coating thickness is measured.

II. Test Method of Light Transmittance, According to GB/T2410-2008

1. Instruments and Equipment

Transmittance/haze tester (Model: WGT-S), cutter

Working environment conditions: (1) ambient temperature: 5° C.-35° C.; (2) relative humidity: not more than 85%.

2. Operation Steps

The sample is cut into the specified size: 50 mm×50 mm; the transmittance tester (WGT-S) is started and preheated for 30 min, and then the sample is flattened and placed on the sample holder of the instrument and fixed. When the fixture is placed, attention should paid to getting it close to the integrating sphere, so that the coating surface is oriented to the incident direction of the light for testing. Three points are tested for each sample. The blank is tested once after testing a group of samples. After that, the test button is pressed to test the next group of samples. The results are taken as an arithmetic mean.

III. Test Methods for Sheet and Adhesion-Related Properties are Performed in Accordance with GB/T 23457-2017.

The present disclosure is illustrated in more detail by the following examples.

1. Preparation of Resin Sheets:

A light stabilizer, an antioxidant, an ultraviolet absorber and a polyolefin resin were sequentially add into a mixer, stirred at a high speed for 10-15 min; the mixed material was extruded through a single screw, with the temperature of an extruder set to be 190° C.-200° C.-220° C.-220° C.-220° C. The polyolefin resin was a mixture of a linear low-density polyethylene resin and a medium-high-density polyethylene resin.

The extruded high-temperature melt was calendered by a three-roller calender to reach a set thickness, forming a sheet. The components, thickness, and light transmittance of the resin sheet layer were shown in Table 1, where the contents of the linear low-density polyethylene and the medium-high-density polyethylene were measured in terms of the total weight of the polyolefin resin (i.e., the sum of both).

TABLE 1

| Component | Sheet 1 | Sheet 2 | Sheet 3 | Sheet 4 |
|---|---|---|---|---|
| Light stabilizer | Chimassorb 2020 | Chimassorb 2020 | Chimassorb 2020 | Chimassorb 2020 |
| | Amount 0.3 wt. % | Amount 0.6 wt. % | Amount 0.3 wt. % | Amount 0.3 wt. % |
| UV absorber | Tinuvin 326 | Tinuvin 326 | Tinuvin 326 | Tinuvin 326 |
| | Amount 0.5 wt. % | Amount 0.5 wt. % | Amount 0.5 wt. % | Amount 1.0 wt. % |
| Antioxidant | Thanox B225 | Thanox B225 | Thanox 1010 | Thanox 1010 |
| | Amount 0.5 wt. % | Amount 0.5 wt. % | Amount 0.5 wt. % | Amount 0.5 wt. % |
| Linear low- | LLDPE-7042 (Qilu) | LLDPE-7042 (Qilu) | Dowlex 2045G | Dowlex 2045G |
| density | Density 0.920 | Density 0.920 | Density 0.920 | Density 0.920 |
| polyethylene | Melt index 1.5 | Melt index 1.5 | Melt index 1.0 | Melt index 1.0 |
| | Amount 70 wt. % | Amount 50 wt. % | Amount 50 wt. % | Amount 30 wt. % |
| Medium-high- | ENABLE 4009MC | ENABLE 4009MC | HDPE TR144 | HDPE TR144 |
| density | Density 0.938 | Density 0.938 | Density 0.946 | Density 0.946 |
| polyethylene | Melt index is 0.91 | Melt index is 0.91 | Melt index 0.20 | Melt index 0.20 |
| | Amount 30 wt. % | Amount 50 wt. % | Amount 50 wt. % | Amount 70 wt. % |
| Light | 80 | 75 | 55 | 50 |
| transmittance, % | | | | |
| Thickness, mm | 0.75 | 1.02 | 1.50 | 1.20 |
| Tensile | 19.5 | 22.9 | 28.0 | 31.0 |
| strength/MPa | | | | |
| Film elongation | 770 | 698 | 935 | 866 |
| at break/% | | | | |
| Nail bar tear | 430 | 458 | 486 | 445 |
| strength/N | | | | |
| Puncture | 355 | 361 | 420 | 376 |
| resistance/N | | | | |
| Thermal aged | 85 | 98 | 88 | 103 |
| tension retention | | | | |
| rate/% | | | | |
| Thermal aged | 96 | 101 | 94 | 98 |
| elongation | | | | |
| retention rate/% | | | | |

2. Preparation of Non-Asphalt-Based Macromolecular Self-Adhesive Layer

The resin sheet prepared in step 1 was unwound through an unwinding drum, the unwound sheet was conveyed between a glue roller and a pressure roller by a guide roller, the glue roller rotated to spread the hot melt adhesive on its surface onto one surface of the sheet to form a non-asphalt-based macromolecular self-adhesive layer, and the components, thickness and light transmittance of the self-adhesive layer were shown in Table 2.

TABLE 2

| Adhesive | Self-adhesive layer 1 | Self-adhesive layer 2 | Self-adhesive layer 3 |
|---|---|---|---|
| Non-asphalt- | SIS Rubber Kraton 1105 | SBS 1401 | SIS Rubber Kraton 1163 |
| based | Amount 36.5 wt. % | Amount 33.0 wt. % | Amount 24.0 wt. % |
| macromolecular | | SBS star shape YH-801 | Daelim PB 1300 |
| elastomer | | Amount 3.5 wt. % | Amount 8.0 wt. % |
| Naphthenic oil | Naphthenic oil Shellflex | Naphthenic oil Shellflex | Naphthenic oil Shellflex |
| | 371 Amount | 371 Amount | 371 Amount |
| | 10.0 wt. % | 10.0 wt. % | 10.0 wt. % |
| Tackifying resin | Tackifying resin Suntack | Tackifying resin Suntack | Tackifying resin Suntack |
| | SR110 | SM100 | SR120H |
| | Amount 52.5 wt. % | Amount 52.5 wt. % | Amount 57.0 wt. % |
| Antioxidant | Antioxidant Irganox 1010 | Antioxidant Irganox 1010 | Antioxidant Irganox 1010 |
| | Amount 0.5 wt. % | Amount 0.5 wt. % | Amount 0.5 wt. % |
| UV absorber | Tinuvin 328 | Tinuvin 328 | Tinuvin 328 |
| | 0.5 wt. % | 0.5 wt. % | 0.5 wt. % |
| Light | 91.0 | 92.0 | 90.5 |
| transmittance, % | | | |
| Thickness, mm | 0.35 | 0.30 | 0.40 |

3. Preparation of an Interface Bonding Layer

The slurry was prepared according to the following formula of the interface bonding layer and uniformly mixed, a proper amount of the slurry was poured on the adhesive layer obtained in step 2 and uniformly coated, and the interface bonding layer was formed after the coating was naturally dried. The components, thickness and light transmittance of the interfacial bonding layer were shown in Table 3, in which the number represented part by weight. A first filler was nano-silica NANOPAL C 750, a second filler was calcium carbonate OMYACARB 2T, and the emulsions were styrene-acrylic emulsion PRIMAL™ AS-8000 and pure acrylic emulsion PRIMAL™ MC-76 LO.

TABLE 3

| | | Product | Paint | Paint | Paint | Paint | Paint | Paint | Paint | Paint | Paint |
|---|---|---|---|---|---|---|---|---|---|---|---|
| Paint | Name | name | 1 | 2 | 3 | 4 | 5 | 6 | 7 | 8 | 9 |
| Pigment | Dispersant | TEGO | 1.5 | 1.5 | 1.5 | 1.5 | 1.5 | 1.5 | 1.5 | 1.5 | 1.5 |
| dispersion | | DIsperse7 | | | | | | | | | |
| slurry | | 55W | | | | | | | | | |
| | Wetting | DYNOL | 1.2 | 1.2 | 1.2 | 1.2 | 1.2 | 1.2 | 1.2 | 0 | 1.2 |
| | agent | 800 | | | | | | | | | |
| | Wetting | TEGO | 0 | 0 | 0 | 0 | 0 | 0 | 0 | 1.2 | 0 |
| | agent | 500 | | | | | | | | | |
| | Water | Deionized | 10 | 35 | 50 | 35 | 35 | 35 | 35 | 35 | 35 |
| | | water | | | | | | | | | |
| | First | NANOPAL | 1 | 1 | 1 | 0.5 | 1.5 | 2 | 0 | 1 | 1 |
| | filler | C 750 | | | | | | | | | |
| | Second | OMYACARB | 28 | 35 | 42 | 35 | 35 | 35 | 55 | 35 | 35 |
| | filler | 2T | | | | | | | | | |
| Paint | Emulsion | PRIMAL ™ | 25 | 25 | 25 | 25 | 25 | 25 | 28 | 25 | 0 |
| mixing | | AS-8000 | | | | | | | | | |
| | Emulsion | PRIMAL ™ | 0 | 0 | 0 | 0 | 0 | 0 | 0 | 0 | 25 |
| | | MC-76 | | | | | | | | | |
| | | LO | | | | | | | | | |
| | Defoamer | TEGO | 0.3 | 0.3 | 0.3 | 0.3 | 0.3 | 0.3 | 0.3 | 0.3 | 0.3 |
| | | Foamex | | | | | | | | | |
| | | 20 | | | | | | | | | |
| | pH | AMP-95 | 0.5 | 0.5 | 0.5 | 0.5 | 0.5 | 0.5 | 0.5 | 0.5 | 0.5 |
| | buffer | | | | | | | | | | |
| | Rheology | TEGO | 0.15 | 0.15 | 0.3 | 0.3 | 0.3 | 0.3 | 0.15 | 0.15 | 0.15 |
| | modifier | Glide 496 | | | | | | | | | |
| | Thickener | ASE 60 | 0 | 0.15 | 0.3 | 0.3 | 0.3 | 0.3 | 0.15 | 0.15 | 0.15 |

| | | | | | | | | | |
|---|---|---|---|---|---|---|---|---|---|
| Coating weight, g/m² | 30 | 42 | 48 | 42 | 45 | 65 | 155 | 45 | 40 |
| Light transmittance, % | 82 | 74.1 | 70.5 | 71.2 | 61.8 | 55.3 | 50 | 70.1 | 71.5 |

### EXAMPLES AND COMPARATIVE EXAMPLES

The waterproof membrane was prepared according to the above steps. The specific type of each layer of the membrane and the evaluation result of the whole membrane were shown in Table 4.

TABLE 4

| Example | | | | | | | |
|---|---|---|---|---|---|---|---|
| 1 | 2 | 3 | 4 | 5 | 6 | 7 | 8 |

| | | | | | | | | |
|---|---|---|---|---|---|---|---|---|
| Resin sheet layer | Sheet | Sheet | Sheet | Sheet | Sheet | Sheet | Sheet | Sheet |
| | 1 | 2 | 3 | 2 | 2 | 2 | 3 | 3 |
| Self-adhesive layer | Self- | Self- | Self- | Self- | Self- | Self- | Self- | Self- |
| | ad- | ad- | ad- | ad- | ad- | ad- | ad- | ad- |
| | hesive | hesive | hesive | hesive | hesive | hesive | hesive | hesive |
| | layer | layer | layer | layer | layer | layer | layer | layer |
| | 1 | 1 | 1 | 1 | 2 | 3 | 1 | 1 |
| Interface bonding | Paint | Paint | Paint | Paint | Paint | Paint | Paint | Paint |
| layer | 1 | 1 | 1 | 2 | 2 | 2 | 3 | 3 |

Evaluation result

| Whole | Light | 73.0 | 67.2 | 47.8 | 68.9 | 66.8 | 63.1 | 67.1 | 58.4 |
|---|---|---|---|---|---|---|---|---|---|
| membrane | trans- | | | | | | | | |
| | mittance, | | | | | | | | |
| | % | | | | | | | | |
| | Thickness, | 1.13 | 1.40 | 1.88 | 1.30 | 1.11 | 1.54 | 1.41 | 1.42 |
| | mm | | | | | | | | |
| Peel strength | | 0.05 | 0 | 0 | 0 | 0 | 0 | 0.03 | 0.05 |
| between anti- | | | | | | | | | |
| adhesion coating | | | | | | | | | |
| and resin layer | | | | | | | | | |
| (N/mm) | | | | | | | | | |
| Peel | No | 3.1 | 3.2 | 2.8 | 2.5 | 3.1 | 1.5 | 3.0 | 2.9 |
| strength | treatment | | | | | | | | |
| with | ≥1.5 | | | | | | | | |
| post- | Immersion | 3.3 | 2.8 | 2.4 | 2.3 | 3.3 | 2.9 | 3.4 | 3.1 |
| cast | water | | | | | | | | |
| concrete/ | treatment | | | | | | | | |
| (N/mm) | ≥1 | | | | | | | | |
| | Sediment | 2.8 | 2.5 | 2.5 | 2.7 | 2.8 | 2.4 | 3.2 | 2.9 |
| | contaminated | | | | | | | | |
| | surface | | | | | | | | |
| | ≥1 | | | | | | | | |
| | Ultraviolet | 1.1 | 1.1 | 1.0 | 1.3 | 1.1 | 1.4 | 1.2 | 1.3 |
| | treatment | | | | | | | | |
| | ≥1 | | | | | | | | |
| | Heat | 2.1 | 2.2 | 1.6 | 2.3 | 2.1 | 2.5 | 2.2 | 2.2 |
| | treatment | | | | | | | | |
| | ≥1 | | | | | | | | |

| | | | | | | | | |
|---|---|---|---|---|---|---|---|---|
| Peel strength after | 3.1 | 3.2 | 2.8 | 2.5 | 2.3 | 3.0 | 2.9 | 2.9 |
| pouring concrete | | | | | | | | |
| and then soaking in | | | | | | | | |
| water for 28 days, | | | | | | | | |
| N/mm | | | | | | | | |

| | | | | | | Compar- | |
|---|---|---|---|---|---|---|---|
| | | | | | | ative | |
| | | Example | | | | example | |
| | | 9 | 10 | 11 | 12 | 1 | 2 |
| Resin sheet layer | | Sheet | Sheet | Sheet | Sheet | Sheet | Sheet |
| | | 3 | 2 | 2 | 2 | 4 | 2 |
| Self-adhesive layer | | Self- | Self- | Self- | Self- | Self- | Self- |
| | | ad- | ad- | ad- | ad- | ad- | ad- |
| | | hesive | hesive | hesive | hesive | hesive | hesive |
| | | layer | layer | layer | layer | layer | layer |
| | | 1 | 1 | 2 | 1 | 1 | 1 |
| Interface bonding | | Paint | Paint | Paint | Paint | Paint | Paint |
| layer | | 3 | 8 | 8 | 9 | 1 | 7 |
| Evaluation result | | | | | | | |
| Whole | Light | 46.5 | 66.3 | 67.1 | 65.4 | 40.4 | 35.0 |
| membrane | trans- | | | | | | |
| | mittance, | | | | | | |
| | % | | | | | | |
| | Thickness, | 1.47 | 1.43 | 1.38 | 1.15 | 1.13 | 1.41 |
| | mm | | | | | | |
| Peel strength | | 0 | 0 | 0 | 0 | 0.03 | 0.05 |
| between anti- | | | | | | | |
| adhesion coating | | | | | | | |
| and resin layer | | | | | | | |
| (N/mm) | | | | | | | |
| Peel | No | 2.7 | 1.7 | 1.2 | 1.7 | 1.2 | 0.5 |
| strength | treatment | | | | | | |
| with | ≥1.5 | | | | | | |
| post- | Immersion | 2.7 | 1.7 | 1.5 | 1.6 | 2.6 | 2.3 |
| cast | water | | | | | | |
| concrete/ | treatment | | | | | | |
| (N/mm) | ≥1 | | | | | | |
| | Sediment | 2.9 | 1.5 | 1.5 | 1.8 | 2.6 | Not |
| | contaminated | | | | | | sticky |
| | surface | | | | | | |
| | ≥1 | | | | | | |
| | Ultraviolet | 1.3 | 1.2 | 1.2 | 1.3 | 1.5 | 1.4 |
| | treatment | | | | | | |
| | ≥1 | | | | | | |
| | Heat | 2.1 | 2.8 | 2.7 | 1.2 | 2.8 | Not |
| | treatment | | | | | | sticky |
| | ≥1 | | | | | | |

| | | | | | | |
|---|---|---|---|---|---|---|
| Peel strength after | 2.9 | 1.3 | 1.4 | 1.3 | 2.7 | 0.6 |
| pouring concrete | | | | | | |
| and then soaking in | | | | | | |
| water for 28 days, | | | | | | |
| N/mm | | | | | | |

### Example 13

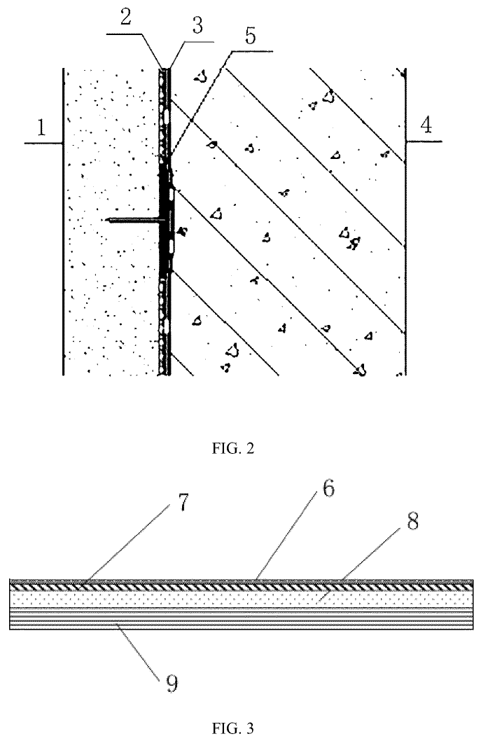

This Example is used to illustrate a tunnel waterproof system provided by the present disclosure. As shown in FIG. 2, the tunnel waterproof system includes an initial support layer 1, a geotextile lining layer 2, a transparent or translucent waterproof membrane layer 3, and a secondary lining layer 4, that are sequentially disposed from inside to outside, where the waterproof membrane layer 3 is fixed on the initial support layer 1 through a nailing gasket 5.

As shown in FIG. 3, the transparent or translucent waterproof membrane layer 3 is provided with a resin sheet layer 6, a non-asphalt-based macromolecular self-adhesive layer 7, an interface bonding layer 8 and an isolation film layer 9, that are disposed sequentially from bottom to top. The waterproof membrane layer 3 has a light transmittance of 73%. The resin sheet layer 6 is a polyethylene-based sheet layer with a thickness of 0.75 mm and a light transmittance of 80%. The non-asphalt-based macromolecular self-adhesive layer 7 is a SIS hot-melt pressure-sensitive adhesive layer with a thickness of 0.35 mm and a light transmittance of 91%. The interface bonding layer 8 is an acrylic polymer emulsion coating layer with a coating layer weight of 30 g/m² and a light transmittance of 82%. The isolation film layer 9 is a PE isolation film layer. The color of the nailing gasket 5 is red.

According to the present disclosure, the gasket may be accurately positioned through the membrane in the light environment of tunnels, so that the membrane and the gasket may be welded and fixed from the front of the membrane by an electromagnetic welder, and the construction speed is high. Compared with welding and fixing from the back of the membrane, two thirds of time may be saved, so that the construction efficiency is greatly improved, and the technical requirements for operators are reduced.

Various embodiments of the present disclosure are described above, and the above description is exemplary and not exhaustive, and is not limited to the disclosed embodiments. Without departing from the scope and spirit of the illustrated embodiments, many modifications and variations will be apparent to those of ordinary skill in the art.

What is claimed is:

1. A waterproof membrane, comprising a resin sheet layer, a non-asphalt-based macromolecular self-adhesive layer and an interface bonding layer which are sequentially disposed, wherein the waterproof membrane has a light transmittance of ≥45%; the resin sheet layer has a thickness of 0.2-1.5 mm and a light transmittance of ≥55%.

2. The waterproof membrane according to claim 1, wherein the resin sheet layer has a thickness of 0.5-1.5 mm and a light transmittance of ≥70%;
the non-asphalt-based macromolecular self-adhesive layer has a thickness of 0.1-1.0 mm, and has a light transmittance of ≥80%;
the interface bonding layer has a coating weight of 20-150 g/m² and a light transmittance of ≥55%.

3. The waterproof membrane according to claim 1, wherein the resin sheet layer is made of a polyolefin resin composition, and the polyolefin resin composition comprises the following components by a total weight of the polyolefin resin composition: 0.05-2 wt. % of light stabilizer, 0.2-5 wt. % of antioxidant, 0.05-2 wt. % of ultraviolet absorber, and 95-99.7 wt. % of poly olefin resin.

4. The waterproof membrane according to claim 3, wherein the polyolefin resin is at least one of polyethylene, vinyl copolymer, polypropylene, propylene-based copolymer, poly (1-butene), poly (4-methyl-1-pentene), and cycloolefin polymer; the vinyl copolymer is ethylene-vinyl acetate copolymer, ethylene-acrylic acid copolymer, or ethylene-acrylate copolymer.

5. The waterproof membrane according to claim 4, wherein the polyolefin resin is polyethylene;
the linear low-density polyethylene resin has a density of 0.915-0.935 g/cm³, and has a melt index I_{2.16} of 0.1-8 g/10 min;
the medium-high-density polyethylene resin has a density of 0.938-0.968 g/cm³; and has a melt index I_{2.16} of 0.1-8 g/10 min.

6. The waterproof membrane according to claim 5, wherein the polyolefin resin is a mixture of linear low-density polyethylene resin and medium-high-density polyethylene resin; and based on a total weight of the polyolefin resin, the linear low-density polyethylene resin has a content of 35-75 weight % and the medium-high-density polyethylene resin has a content of 25-65 weight %.

7. The waterproof membrane according to claim 3, wherein the light stabilizer is a hindered amine light stabilizer selected from at least one of 2-(3,5-di-tert-butyl-4-hydroxybenzyl)-2′-n-butyl bis(1,2,2,6,6-pentamethyl-4-piperidyl) malonate, bis(1,2,2,6,6-pentamethyl-4-piperidyl) sebacate, and tetrakis(2,2,6,6-tetramethyl-4-piperidinyl)-1,2,3,4-butane tetracarboxylate;
the antioxidant is selected from at least one of pentaerythritol tetrakis (3,5-di-tert-butyl-4-hydroxyphenyl) propionate and 1,3,5-trimethyl-2,4,6-tris-(3,5-di-tert-butyl-4-hydroxy-phenyl) benzene;
the ultraviolet absorber is selected from at least one of hydroxyphenyl triazine ultraviolet absorber and benzotriazole ultraviolet absorber, the hydroxyphenyl triazine ultraviolet absorber is at least one of 2,4-bis(2,4-dimethylphenyl)-6-(2-hydroxy-4-n-octyloxyphenyl)-s-triazine, 2,4,6-tris(2-hydroxy-4-hexyloxy-3-methylphenyl)-s-triazine, 2-[2-hydroxy-4-(2-ethylhexyloxy)phenyl]-4,6-diphenyl-s-triazine, 2-[[2-hydroxy-4-[1-(2-ethylhexyloxycarbonyl)ethoxy]phenyl]]-4,6-diphenyl-s-triazine; and the benzotriazole ultraviolet absorber is 2-(5-chloro-2H-benzotriazole-2-yl)-6-tert-butyl-4-methylphenol and 2-(5-chloro-2-benzotriazolyl)-6-tert-butyl-p-cresol.

8. The waterproof membrane according to claim 1, wherein a material of the non-asphalt-based macromolecular self-adhesive layer comprises non-asphalt-based macromolecular elastomer, naphthenic oil, tackifying resin, ultraviolet absorber and antioxidant; based on a total weight of the non-asphalt-based macromolecular self-adhesive layer, the non-asphalt-based macromolecular elastomer has a content of 30-48 weight %, the naphthenic oil has a content of 5-15 weight %, the tackifying resin has a content of 45-60 weight %, the ultraviolet absorber has a content of 0.1-2 weight %, and the antioxidant has a content of 0.1-2 weight %.

9. The waterproof membrane according to claim 1, wherein a material of the non-asphalt-based macromolecular self-adhesive layer is a non-asphalt-based macromolecular self-adhesive pressure-sensitive adhesive, which is one or more of hot-melt pressure-sensitive adhesive of ethylene-vinyl acetate, hot-melt pressure-sensitive adhesive of styrene-isoprene-styrene, butyl rubber-based adhesive, polyisobutylene-based adhesive, acrylic-based adhesive, ethylene-vinyl acetate copolymer adhesive, styrene-isoprene-styrene-based adhesive, styrene-ethylene-butylene-styrene-based adhesive, styrene-butadiene-styrene-based adhesive, and styrene-butadiene rubber-based adhesive.

10. The waterproof membrane according to claim 1, wherein a raw material of the interface bonding layer comprises the following components in percentage by mass:

| | |
|---|---|
| deionized water | 10-50% |
| dispersant | 0.5-5% |
| wetting agent | 0.5-5% |
| defoamer | 0.1-3% |
| rheology modifier | 0.1-3% |
| pH buffer | 0.1-3% |
| thickener | 0.1-3% |
| first filler | 0.5-5% |
| second filler | 20-50% |
| emulsion | 10-40% |

wherein the first filler is a nano-scale inorganic particle and is selected from at least one of nano-silica, nano-rutile-type titanium dioxide, nano zinc oxide, nano antimony-doped tin dioxide, nano alumina, nano zirconia, and nano calcium carbonate;
the second filler is selected from at least one of barium sulfate, calcium carbonate, quartz powder, aluminum silicate, microsilica, and glass powder;
the emulsion is at least one of acrylic polymer emulsion, methacrylic polymer emulsion, acrylic acid-methacrylic acid copolymer emulsion, styrene-acrylic acid copolymer emulsion, pure acrylic emulsion, ethylene-vinyl acetate copolymer emulsion, and polyvinyl acetate emulsion.

11. The waterproof membrane according to claim 1, wherein the waterproof membrane comprises an isolation film layer which is disposed on another side of the interface bonding layer.

12. The waterproof membrane according to claim 1, wherein a single end or both ends of the waterproof membrane are provided with a welded edge or a self-adhesive overlapping edge.

13. A method for preparing the waterproof membrane according to claim 1, comprising the following steps:
S1, melting and extruding raw materials of a resin sheet layer, calendering, and molding to obtain a resin sheet;
S2, coating a hot-melt non-asphalt-based macromolecular self-adhesive on one surface of the resin sheet to form a sheet with a self-adhesive layer;
S3, uniformly coating raw materials of an interface bonding layer on a surface of the self-adhesive layer of the sheet obtained in step S2, and drying to form the interface bonding layer.

14. A construction method of the waterproof membrane according to claim 1, comprising the following steps: adopting a pre-laid reverse-adhering method for construction, wherein the membrane and a base layer are laid emptily, and after laying, reinforcing bars are directly tied without applying a protective layer, and then a structural concrete is poured.

15. The construction method according to claim 14, wherein during construction in a tunnel, the method comprises the following steps: adopting the pre-laid reverse-adhering method for construction, wherein the membrane is fixed on a first lining concrete through a gasket, and after laying, the reinforcing bars are directly tied without applying the protective layer, and then the structural concrete is poured to form full bonding between the membrane and a second lining concrete.

16. The construction method according to claim 15, wherein the gasket has a warm color.

17. The construction method according to claim 16, wherein the warm color is orange or red.

18. A tunnel waterproof system, comprising, an initial support layer, a geotextile lining layer, a transparent or translucent waterproof membrane layer and a secondary lining layer, that are sequentially disposed from inside to outside, wherein the waterproof membrane layer is fixed on the initial support layer through a nailing gasket; and the waterproof membrane layer is a layer formed by the waterproof membrane according to claim 1.

19. The tunnel waterproofing system according to claim 18, wherein the nailing gasket has a warm color.

20. The tunnel waterproofing system according to claim 19, wherein the nailing gasket is orange or red.
